(19) United States
(12) Patent Application Publication
(10) Pub. No.: US 2020/0387024 A1
(43) Pub. Date: Dec. 10, 2020

(54) DISPLAY PANEL AND DISPLAY DEVICE

(71) Applicant: SHARP KABUSHIKI KAISHA, Osaka (JP)

(72) Inventor: HIROTO AKIYAMA, Sakai City (JP)

(21) Appl. No.: 16/892,822

(22) Filed: Jun. 4, 2020

Related U.S. Application Data
(60) Provisional application No. 62/858,077, filed on Jun. 6, 2019.

(51) Int. Cl. G02F 1/1333; G02F 1/1335

(52) U.S. Cl. CPC G02F 1/133345; G02F 1/133512

(57) ABSTRACT

A display panel includes the following: a first substrate on which a light-blocking film and a conductive film are disposed; a second substrate on which a ground is disposed; and a liquid-crystal layer composed of an electro-optical substance disposed between the substrates. The conductive film and the ground are connected together by a conductive connector extending over a side edge of the first substrate located in the non-display area. The light-blocking film includes a main light-blocking film including an intra-display-area light-blocking portion disposed in a display area, and includes an isolated light-blocking film including a portion of the side edge adjacent to where the connector is located. The isolated light-blocking film is in the non-display area and is electrically isolated from the main light-blocking film.

### TECHNICAL FIELD

The Specification discloses a technique relating to a display panel and a display device.

### BACKGROUND ART

A display panel is known that includes electro-optical substances (e.g., liquid crystals) between a pair of substrates facing each other. This display panel displays an image by changing the state of light transmission through application of an electric field to the electro-optical substances. Such a display panel in which an electrode for field application is mounted on only one of the substrates easily exhibits charge-up when the other substrate without an electrode is applied with static electricity from outside the display panel. Accordingly, a conductive shield film is provided on the outer surface of the substrate without an electrode and is brought into electrical connection with a ground provided on the electrode-mounted substrate, thus reducing effects of static electricity and of other things. Unfortunately, the substrate without an electrode is provided with a light-blocking film that is typically conductive. In addition, when the potential of the conductive shield film and the potential of the ground transmit into an image display area, an unintended electric field is generated, thus causing faulty display in some cases.

For instance, Japanese Patent Application Laid-Open No. 2011-22182 below discloses a liquid-crystal display that includes a pair of substrates facing each other via a liquid-crystal layer. One of the substrates is provided with no electrodes. Disposed on the outer surface of this electrode-free substrate is a conductive film connected to a ground via a conductive connector. The liquid-crystal display also includes a light-blocking film on the electrode-free substrate. The light-blocking film has a cutout at a site where the connector is disposed. The cutout is wider than the connector is. The light-blocking film also has an insulating-resin protrusion extending along the cutout. In this configuration, providing a cutout in the light-blocking film, at the site where the connector is disposed moves an end surface of the light-blocking film backward from a side edge of the substrate. Furthermore, providing a protrusion at the side edge of the substrate in such manner that the protrusion faces the end surface of the light-blocking film prevents contact between the connector and the light-blocking film. Such a configuration, which requires a cutout and protrusion to be provided individually, unfortunately involves a complicated structure and complicated manufacturing process steps. In addition, there is a possibility of light leakage from the cutout of the light-blocking film.

### SUMMARY OF INVENTION

To solve the above problems, it is an object of the technique in the Specification to reduce an unintended electric field generated in a display area and to prevent an occurrence of faulty display, using a simple configuration.

(1) A preferred embodiment of the technique disclosed in the Specification provides a display panel that includes first and second substrates facing each other, and an electro-optical substance disposed between the first and second substrates. The display panel is sectioned into a display area where an image is displayed, and a non-display area where an image is not displayed. The first substrate includes a light-blocking film disposed in the display area and the non-display area, and is adjacent to the electro-optical substance. The light-blocking film is conductive and impervious to light. The first substrate also includes a conductive film that is remote from the electro-optical substance. The conductive film is conductive. The display panel includes a ground disposed outside the first substrate. The ground is kept at a ground potential. The conductive film and the ground are connected together by a connector that is conductive and extends over a side edge of the first substrate located in the non-display area. The light-blocking film includes a main light-blocking film including an intra-display-area light-blocking portion disposed in the display area, and an isolated light-blocking film disposed in the non-display area including a portion of the side edge adjacent to where the connector is disposed. The isolated light-blocking film is electrically isolated from the main light-blocking film.

(2) The display panel according to a preferred embodiment of the technique disclosed in the Specification is configured, in addition to Configuration (1), such that the second substrate includes a pair of electrodes for applying an electric field to the electro-optical substance, and includes the ground.

(3) The display panel according to a preferred embodiment of the technique disclosed in the Specification is configured, in addition to Configuration (1) or (2), such that the first substrate includes an insulating blockage film that is insulating. The insulating blockage film extends continuously from a surface of the isolated light-blocking film adjacent to the electro-optical substance to a surface of the main light-blocking film adjacent to the electro-optical substance.

(4) The display panel according to a preferred embodiment of the technique disclosed in the Specification is configured, in addition to Configuration (3), such that the first substrate includes an insulating protective film that is insulating. The insulating protective film is disposed on a surface of the intra-display-area light-blocking portion adjacent to the electro-optical substance, and such that the insulating blockage film is contiguous to the insulating protective film.

(5) The display panel according to a preferred embodiment of the technique disclosed in the Specification is configured, in addition to any of Configurations (1) to (4), such that the isolated light-blocking film extends along the entire length of the side edge of the first substrate.

(6) The display panel according to a preferred embodiment of the technique disclosed in the Specification is configured, in addition to any of Configurations (1) to (5), such that the connector is impervious to light, and covers an area located between the isolated light-blocking film and the main light-blocking film in plan view.

(7) The display panel according to a preferred embodiment of the technique disclosed in the Specification is configured, in addition to any of Configurations (1) to (6), such that the connector is composed of a conductive paste.

(8) A preferred embodiment of the technique disclosed in the Specification provides a display device that includes the display panel according to any of Configurations (1) to (7).

The technique in the Specification prevents, using a simple configuration, faulty display resulting from an unintended electric field generated in a display area.

### BRIEF DESCRIPTION OF DRAWINGS

FIG. 1 is a schematic diagram illustrating the connection configuration of a liquid-crystal display according to a first preferred embodiment;

FIG. 2 is a schematic cross-sectional view of a display area of a liquid-crystal panel;

FIG. 3 is a schematic cross-sectional view taken along line A-A in FIG. 1;

FIG. 4 is a schematic plan view of the joint between a light-blocking film and a ground;

FIG. 5 is a schematic plan view of the joint between a light-blocking film that is not isolated and the ground;

FIG. 6 is a schematic cross-sectional view of the joint between a light-blocking film that is not isolated and the ground,

FIG. 7 is a schematic plan view of the joint between a light-blocking film according to a second preferred embodiment and the ground; and

FIG. 8 is a schematic plan view of the joint between a light-blocking film according to a third preferred embodiment and the ground.

### DESCRIPTION OF PREFERRED EMBODIMENTS

### First Preferred Embodiment

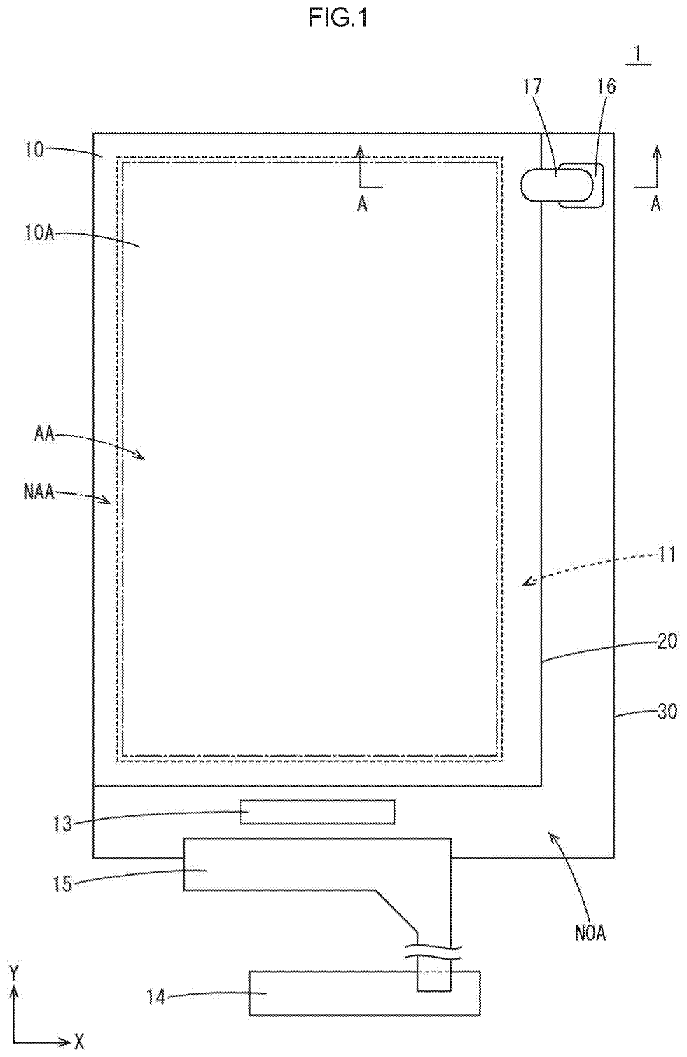

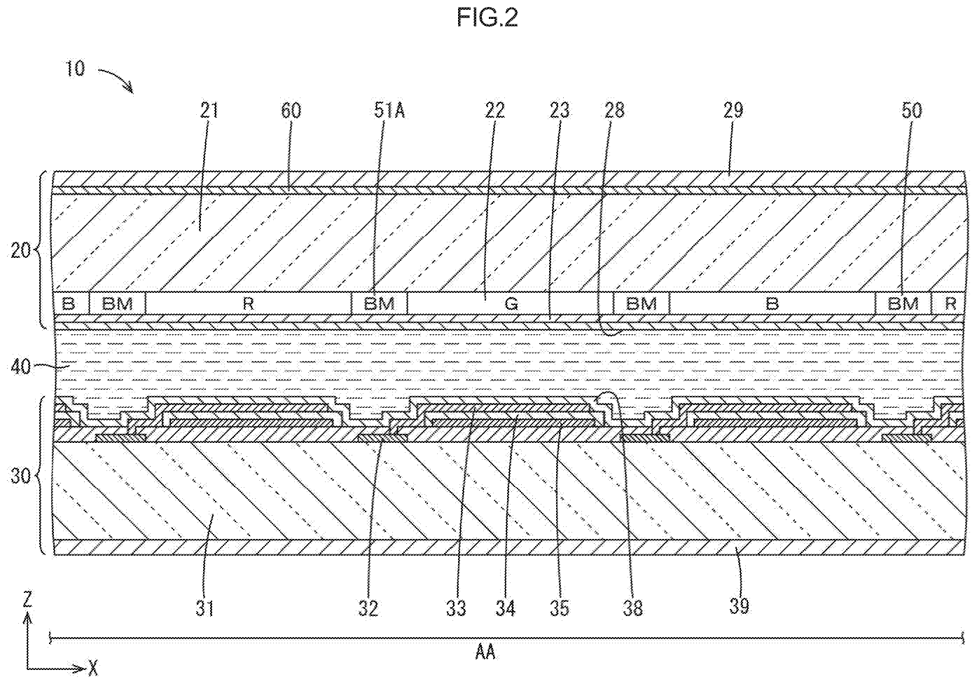

A first preferred embodiment will be described with reference to FIGS. 1 to 6. The first preferred embodiment describes a liquid-crystal display 1 (which is an example of a display device) by way of example only. There are an X-axis, Y-axis, and Z-axis shown in part of each drawing, and the direction of each axis is oriented in the same direction throughout the drawings. The upper, lower, left, and right sides of FIG. 1 respectively correspond to the upper, lower, left, and right sides of the liquid-crystal display 1. The upper and lower sides of FIG. 2 respectively correspond to the front and back sides of the liquid-crystal display 1. In some cases, for convenience in description, each drawing omits some components and illustrates the simplified shape of each component. Reference is made to multiple identical components illustrated in each drawing. In some cases, one of the identical components is accompanied with a sign, and the others are not accompanied with the sign. This holds true for second and third preferred embodiments.

As shown in FIG. 1, the liquid-crystal display 1 includes a liquid-crystal panel 10 (which is an example of a display panel) capable of displaying an image. The liquid-crystal display 1 according to this preferred embodiment is overall a rectangular shallow box in appearance. The liquid-crystal panel 10 may be provided with, on its back surface, a backlight that serves as an external power source for casting light to display an image onto the liquid-crystal panel 10. The liquid-crystal display 1 may be configured such that the liquid-crystal panel 10 has, on its front surface, a frame for instance, which together with the backlight, sandwiches and holds the perimeter of the liquid-crystal panel 10 (i.e., a non-display area NAA, which will be described later on).

The liquid-crystal display 1 according to the first preferred embodiment is usable in various pieces of electronic equipment (not shown), such as a laptop computer (including a tablet laptop personal computer), a mobile phone terminal (including a smartphone), a wearable terminal (including a smart watch), a mobile information terminal (including an electronic book and a PDA), a vehicle-installed information terminal (including a navigation system), and a mobile game machine. The screen size of the liquid-crystal panel 10 can be several to some ten inches large, which typically falls under a category of small size or small-to-mid size. The present technique is suitable for use particularly in a liquid-crystal display that is relatively small and inevitably includes components at small intervals. The present technique is nevertheless usable in a display device as well whose screen size falls under a category of mid-size or large-size (or super-large-size) of several ten inches or more.

The liquid-crystal panel 10 displays an image on its front surface, which is herein an image display surface 10A. Although the liquid-crystal panel 10 can have any well-known configuration, the present technique is suitable for use particularly in a liquid-crystal panel in transverse-field mode (such as an in-planer switching mode or IPS mode for short, and a fringe-field switching mode or FFS mode for short) where an electric field substantially parallel to a substrate surface is applied. The liquid-crystal panel 10 in this preferred embodiment operates in FFS mode by way of example only.

As shown in FIG. 1, the liquid-crystal panel 10 is rectangular in plan view. In the following description, the shorter sides of the liquid-crystal panel 10 correspond with the X-axis direction (or side-to-side direction), and the longer sides of the same correspond with the Y-axis direction (or up-and-down direction). The liquid-crystal panel 10 is sectioned into a display area (or active area) AA where an image is displayed, and a non-display area (or non-active area) NAA where an image is not displayed. The display area AA is in the middle of the image display surface 10A. The non-display area NAA is at the perimeter of the image display surface 10A and is in the form of a frame (or ring) surrounding the display area AA. In FIG. 1, the rectangular dot-dashed line denotes the outer edge of the display area AA, and the area outside the rectangular dot-dashed line is the non-display area NAA. The liquid-crystal panel 10 includes a pair of substrates 20 and 30 having different sizes.

The substrate 20 is also referred to as a CF substrate 20 (i.e., a counter substrate, which is an example of a first substrate) that is disposed on the front side of the liquid-crystal display 1. The substrate 30 is also referred to as an array substrate 30 (i.e., an active matrix substrate, TFT substrate, or element substrate, which is an example of a second substrate) that is disposed on the back side of the liquid-crystal display 1. As shown in FIG. 1, the shorter and longer sides of the CF substrate 20 are smaller than those of the array substrate 30. In addition, the CF substrate 30 is attached to the array substrate 30 with its left and upper edges superposed on those of the array substrate 30. The substrates 20 and 30 are attached together by a sealant 11, which surrounds the display area AA, with a predetermined gap therebetween. In FIG. 1, the sealant 11 lies between the perimeter of the CF substrate 20 and the size smaller, rectangular dot line.

As shown in FIG. 1, the right and lower edges of the perimeter of the array substrate 30 do not overlap the CF substrate 20 over a predetermined range, and the front and back surfaces of the array substrate 30 are thus exposed to the outside. This exposed region can be also referred to as a substrate non-overlap area NOA. In this preferred embodiment, the array substrate 30 includes, in the substrate non-overlap area NOA along its lower edge, a driver 13 (i.e., a panel driver or display-element driver) for driving the liquid-crystal panel 10, and a flexible substrate 15 (i.e., a wiring member used for the display panel) for supplying various signals from a control substrate 14 to the liquid-crystal panel 10. In this preferred embodiment, the array substrate 30 further includes a ground 16 in the substrate non-overlap area NOA along its right side edge. The ground 16 is for instance electrically connected to a ground circuit disposed on the control substrate 14, via wires and conductive layers disposed on the flexible substrate 15 and the array substrate 30. The ground 16 is thus kept at a ground potential. The ground 16 can be formed, for instance by forming a gate insulating film (i.e., an insulating film) and a second metal film (i.e., source metal film), both of which will be described later on, in the non-display area NAA.

FIG. 2 shows a liquid-crystal material sealed in the gap between the substrates 20 and 30, thus forming a liquid-crystal layer 40. The liquid-crystal material contains liquid-crystal molecules, each of which is an electro-optical substance whose optical property changes upon field application. The liquid-crystal material can be any known material without limitations. The substrate 20 includes an alignment film 28 of polyamide for instance that is disposed on its innermost surface to be in contact with the liquid-crystal layer 40. The substrate 30 includes an alignment film 38 of polyamide for instance that is disposed on its innermost surface to be in contact with the liquid-crystal layer 40. The alignment films 28 and 38 align the liquid-crystal molecules, contained in the liquid-crystal layer 40, toward a predetermined direction.

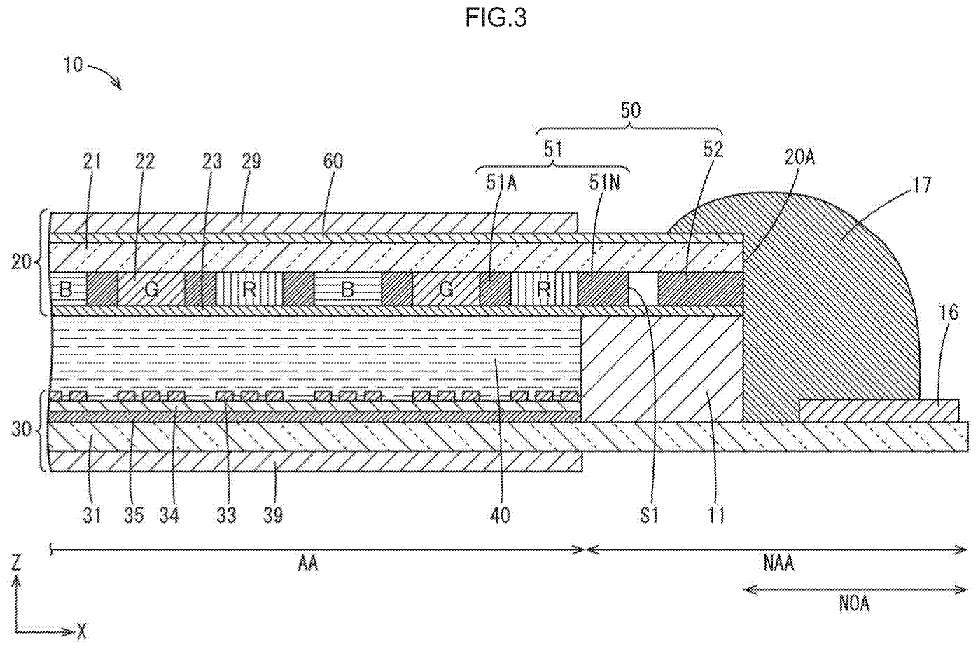

As shown in FIG. 2, the substrates 20 and 30 respectively include transparent substrates 21 and 31 of glass that are substantially transparent and have high transparency to light. The transparent substrate 21 has an outermost surface (i.e., a surface remote from the liquid-crystal layer 40) on which a polarizer plate 29 is attached. The transparent substrate 31 has an outermost surface (i.e., a surface remote from the liquid-crystal layer) on which a polarizer plate 39 is attached. The polarizer plates 29 and 39 are vertically oriented rectangles that are substantially congruent in plan view and cover the whole display area AA. The longer sides and shorter sides of the polarizer plates 29 and 39 are smaller than those of the transparent substrate 21 are. Thus, at least at the perimeter of the non-display area NAA, the outer surfaces of the substrates 20 and 30 are not covered with the respective polarizer plates 29 and 39, and are thus exposed (c.f., FIG. 3).

As shown in FIG. 2, the transparent substrate 31 of the array substrate 30 has an inner surface (i.e., a surface adjacent to the liquid-crystal layer 40, a surface facing the CF substrate 20) on which multiple thin film transistors (TFTs, which are switching elements or display elements) 32 and multiple pixel electrodes 33 are disposed. The TFTs 32 and the pixel electrodes 33 are arranged in the display area AA in matrix (i.e., in rows and columns). The TFTs 32 and the pixel electrodes 33 are surrounded by gate wires (i.e., scanning lines) and source wires (i.e., data lines or signal lines) arranged in the form of a lattice. In each drawing in this preferred embodiment, the direction where the gate wires extend corresponds to the X-axis direction, and the direction where the source wires extend corresponds to the Y-axis direction. FIG. 2 also shows common electrodes 35 disposed under the pixel electrodes 33 (i.e., near the transparent substrate 31) via second interlayer insulating films 34, which will be described later on. Each pixel electrode 33 is overall rectangular in plan view in an area defined by the gate and source wires. The pixel electrode 33 has multiple slits extending along the source wires, that is, along the Y-axis, and is thus shaped like a substantial comb teeth. Each common electrode 35 is provided in the form of a generally flat pattern. Each TFT 32 has a gate electrode, a source electrode, a drain electrode, and a channel area disposed between the source and drain electrodes. The gate electrode, and source electrode, and drain electrode of the TFT 32 are respectively connected to the gate wire, source wire, and pixel electrode 33.

The above structures are composed of various films laminated on the transparent substrate 31. For instance, these structures are composed of a predetermined pattern of lamination formed through known photolithography; That is, a first metal film (i.e., a gate metal film), a gate insulating film (i.e., an insulating film) a semiconductor film, a second metal film (i.e., a source metal film), a first interlayer insulating film, an organic insulating film, a first transparent electrode film, the second interlayer insulating film 34, a second transparent electrode film, and the alignment film 38 are laminated in this order from the lower part of the lamination (from the transparent substrate 31). The first and second metal films each can be composed of a monolayer film made of a single kind of metal material selected from among, for instance, copper, titanium, aluminum, molybdenum, and tungsten; alternatively, these metal films each can be composed of a laminated film made of different kinds of metal material selected from among the foregoing materials; alternatively, these metal films each can be composed of an alloy of the foregoing materials. The first metal film constitutes the gate wires or other things, and the second metal film constitutes the source wires and other things. The semiconductor film can be composed of a silicon semiconductor, such as an amorphous silicon semiconductor, or can be composed of an oxide semiconductor, such as an indium-gallium-zinc-oxide (IGZO) semiconductor. The semiconductor film constitutes the channel areas of the TFTs 32. The first and second transparent electrode films each can be made of indium tin oxide (ITO) or zinc oxide (ZnO). The first transparent electrode film constitutes the common electrodes 35, and the second transparent electrode film constitutes the pixel electrodes 33. The gate insulating film, the first interlayer insulating film, and the second interlayer insulating film 34, all of which are disposed between the foregoing films, each can be made of an inorganic material, such as silicon nitride (SiNx) or silicon oxide (SiO2).

As shown in FIG. 2, the transparent substrate 21 of the CF substrate 20 has an inner surface (i.e., a surface adjacent to the liquid-crystal layer 40, a surface facing the array substrate 30) on which multiple color filters 22 are arranged in matrix so as to face the respective pixel electrodes 33 of the array substrate 30. The color filters 22 are composed of colored films of three colors: red (R), green (G), and blue (B) repeatedly arranged in parallel in a predetermined order. Disposed between the color filters 22 are inter-pixel light-blocking portions 51A (which are an example of intra-display-area light-blocking portions) for avoiding color mixture. The inter-pixel light-blocking portions 51A are disposed over the gate and source wires of the array substrate 30 in plan view, and are provided in the form of a lattice. Disposed on the surface of the color filters 22 and inter-pixel light-blocking portions 51A is an overcoat film 23 (which is an example of an insulating protective film). It is noted that photo-spacers may be provided in an appropriate location on the surface of the overcoat film 23 in order to keep the gap between the substrates 20 and 30 at a predetermined interval.

The above structures are composed of various films laminated on the transparent substrate 21. For instance, these structures are composed of a predetermined pattern of lamination formed through known photolithography; That is, a light-blocking film 50, which is a black matrix (c.f., FIG. 3 for instance), the colored films, the overcoat film 23, and the alignment film 28 are laminated in this order from the lower part of the lamination (from the transparent substrate 21). The light-blocking film 50 can be made of a lightproof resin material containing, for instance, carbon black and a metal material. The details will be described later on. In this preferred embodiment, the light-blocking film 50 includes a main light-blocking film 51 (c.f., FIG. 3 for instance) part of which constitutes the inter-pixel light-blocking portion 51A. The details will be described later on. Each colored film can be made of a light-pervious resin material containing, for instance, a corresponding color pigment, and constitutes the color filter 22 of the corresponding color. The overcoat film 23 can be made of a transparent insulating resin material, such as acrylic.

In the liquid-crystal panel 10 having the substrates 20 and 30 as described above, a set of three colored films of R, G, and B of the color filters 22, and of three pixel electrodes 33 facing the colored films constitute a single display pixel, which is a display unit. Each display pixel consists of a red pixel having the color filter 22 of R, a green pixel having the color filter 22 of G, and a blue pixel having the color filter 22 of B. The display pixels having these colors are repeatedly arranged on the surface of the liquid-crystal panel 10 in parallel in lows (i.e., in the X-axis direction), thus constituting a group of display pixels. Further, multiple groups of display pixels are arranged in parallel in columns (i.e., in the Y-axis direction).

The following outlines the operation of the liquid-crystal panel 10. In the liquid-crystal panel 10 having the aforementioned configuration, each TFT 32 controls potential supply to the pixel electrode 33 when driven based on various signals supplied individually to the gate and source wires of the array substrate 30. Controlling the potential applied to the pixel electrode 33 can generate a predetermined potential difference between the pixel electrode 33 and the common electrode 35. When the potential difference is generated between the pixel electrode 33 and the common electrode 35, a fringe electric field (or oblique electric field) containing a component in the direction of the normal to the surface of the array substrate 30, as well as a horizontal electric field parallel to the surface of the array substrate 30, is applied to the liquid-crystal layer 40 via the slits of the pixel electrode 33. Controlling this electric field timely changes the alignment state of the liquid-crystal molecules within the liquid-crystal layer 40.

As earlier described, the polarizer plates 29 and 39, which selectively let only light vibrating in a particular direction pass therethrough, are respectively attached on the outer surface of the substrate 20 and the outer surface of the substrate 30. Light that is emitted from the backlight, passes through the polarizer plate 39 on the back side, and enters the liquid-crystal layer 40 propagates forward (i.e., in the Z-axis direction) through the liquid-crystal layer 40 while changing the state of polarization in accordance with the alignment state of the liquid-crystal molecules, and only light capable of passing through the polarizer plate 29 on the front side goes out as display light. As earlier described, controlling the electric field, applied to the liquid-crystal layer 40 to change the alignment state of the liquid-crystal molecules, changes the transmittance of light that passes through the liquid-crystal panel 10, thus displaying an image on the front surface of the liquid-crystal panel 10, that is, on the image display surface 10A.

As described above, the liquid-crystal panel 10 according to this preferred embodiment operates in FFS mode, which is a kind of transverse-field mode. The liquid-crystal panel 10 is configured such that the pixel electrodes 33 and the common electrodes 35, both of which are used for applying an electric field to the liquid-crystal layer 40, are disposed on the array substrate 30. The liquid-crystal display 10 is also configured such that no electrodes are disposed on the CF substrate 20. The CF substrate 20 is hence more likely to exhibit charge-up resulting from static electricity built up on its surface than the array substrate 30 is. When a vertical electric field occurs resulting from such a noise, an unintended electric field is applied to the liquid-crystal layer 40, thus possibly causing faulty display. Furthermore, when the liquid-crystal panel 10 has inside a touch panel pattern (which means the liquid-crystal panel 10 has an in-cell touch panel) so as to have multiple functions, a touch signal is affected by a noise outside the liquid-crystal panel 10, to slow down, thereby possibly causing a failure to perform the touch-panel function properly, such as a decrease in touch sensitivity.

Accordingly, the CF substrate 20 according to this preferred embodiment includes, as shown in FIGS. 2 and 3, a conductive film 60 for shielding that extends substantially all across the outer surface of the transparent substrate 21 to reduce effects of a noise resulting from statistic electricity and other factors. The conductive film 60 can be made of a transparent conductive material, including indium tin oxide (ITO) and zinc oxide (ZnO). The conductive film 60 in this preferred embodiment is between the transparent substrate 21 and the polarizer plate 29. As earlier described, the perimeter of the CF substrate 20 in the non-display area NAA has an area that is not covered with the polarizer plate 29, and from which the conductive film 60 is exposed, as shown in FIG. 3. In this preferred embodiment, the exposed conductive film 60 at the perimeter of the CF substrate 20 is electrically connected to the aforementioned ground 16, disposed in the substrate non-overlap area NOA along the right side edge of the array substrate 30, via a conductive silver paste 17 (which is an example of a connector, a conductive paste) extending over a right side edge 20A (which is an example of a side edge) of the CF substrate 20. The conductive film 60 is accordingly kept at the ground potential, thus preventing an electrical charge in the CF substrate 20. This reduces effects of a noise, such as static electricity.

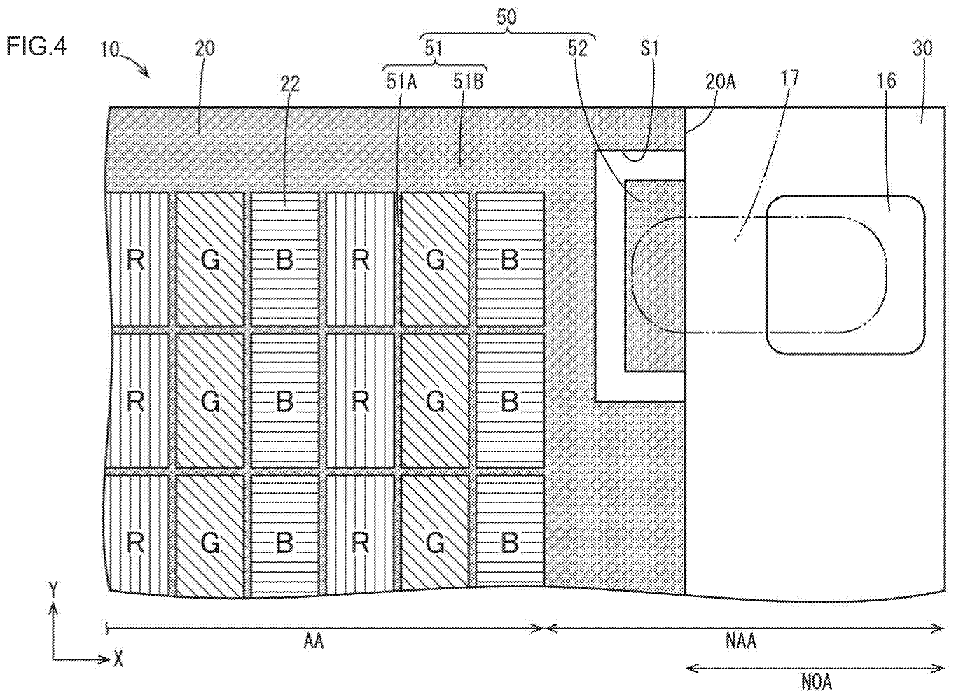

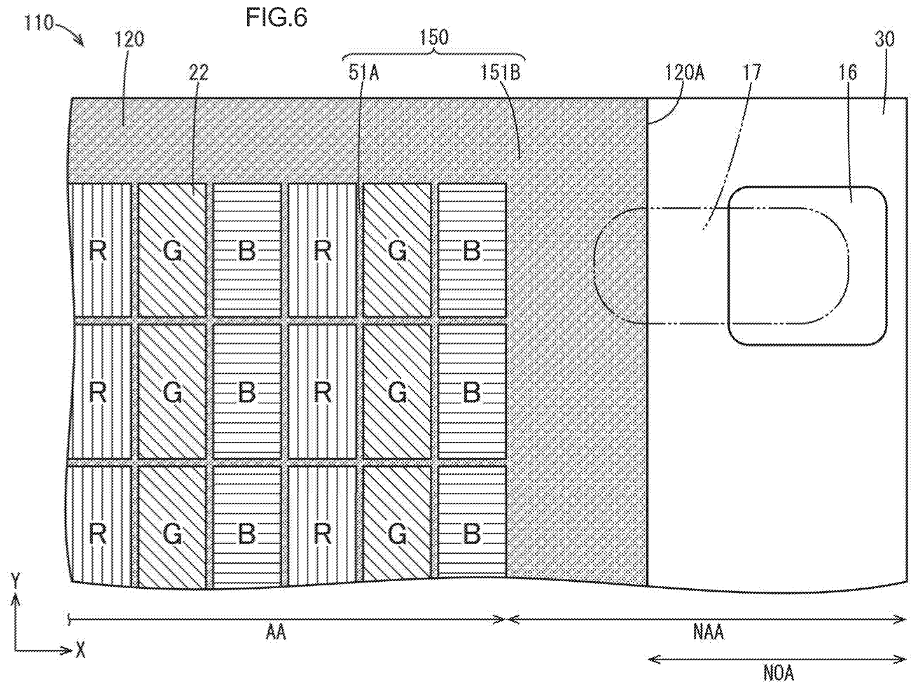

The light-blocking film 50, which is disposed on the CF substrate 20 and stops light from transmission, contains carbon black and a metal material as earlier described, and is thus conductive. The light-blocking film 50 extends not only in the display area AA, but also in the non-display area NAA. The light-blocking film 50 in the display area AA corresponds to the aforementioned inter-pixel light-blocking portion 51A. The inter-pixel light-blocking portions 51A are disposed between the display pixels in the form of a lattice, as shown in FIGS. 3 and 4, to avoid color mixture and enhance contrast. The light-blocking film 50 in the non-display area NAA, which is provided in the form of a frame, regulates light leaking from this location, and enhances contrast. The inter-pixel light-blocking portion 51A in the display area AA and the frame portion in the non-display area NAA are normally contiguous to each other with a predetermined pattern. FIG. 4 is a front plan view of part of the liquid-crystal panel 10 before application of the silver paste 17 (denoted by a dot-dot-dash line in FIG. 4). For convenience in description, FIG. 4 omits the transparent substrate 21, conductive film 60, and polarizer plate 29 of the CF substrate 20, all of which are omitted also in FIGS. 6, 7, and 8.

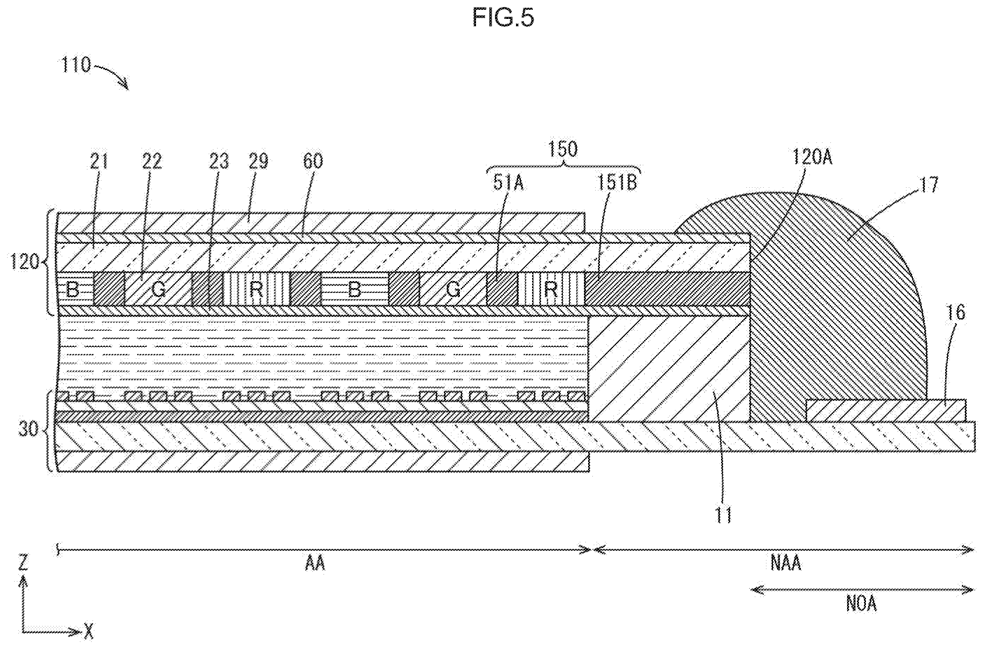

As shown in FIGS. 3 and 4, the light-blocking film 50 according to this preferred embodiment includes the main light-blocking film 51 and an isolated light-blocking film 52 electrically isolated from the main light-blocking film 51. To describe an effect of such a configuration, the following describes a comparative example where a liquid-crystal panel 110 has a light-blocking film 150 that extends continuously in its entirety, with reference to FIGS. 5 and 6.

This comparative liquid-crystal panel 110 has a frame-shaped light-blocking portion 151B extending continuously from the lattice-shaped inter-pixel light-blocking portion 51A so as to continuously cover all across a part of the non-display area NAA in which the array substrate 30 and a CF substrate 120 are superposed on each other. That is, the light-blocking film 150 is a single continuous film in its entirety extending from the display area AA to the non-display area NAA. The frame-shaped light-blocking portion 151B, which is close to the silver paste 17, and the inter-pixel light-blocking portion 51A are accordingly electrically connected together as shown in FIG. 5. For instance, a failure to satisfactorily cut off the transparent substrate 21 of the CF substrate 120 can bring the silver paste 17 into contact with the frame-shaped light-blocking portion 151B nearby, at a right side edge 120A of the CF substrate 120 over which the silver paste 17 extends. In a configuration like the liquid-crystal panel 110 where the light-blocking film 150 is provided as a single-piece film in its entirety, and where the frame-shaped light-blocking portion 151B near the silver paste 17 and the inter-pixel light-blocking portion 51A are contiguous to each other, the potentials of the conductive film 60, ground 16, and other things transmit from the frame-shaped light-blocking portion 151B to the inter-pixel light-blocking portion 51A within the display area AA via the silver paste 17. In detail, when the inter-pixel light-blocking portion 51A becomes the ground potential (i.e., 0 V) gradually from the right, which is close to the frame-shaped light-blocking portion 151B in contact with the silver paste 17, the color filter 22 of G, having the smallest resistivity of the three color filters 22 of red (R), green (G), and blue (B), firstly changes to the ground potential. As a result, the green pixel particularly exhibits a vertical electric field (i.e., an electric field in the direction of the normal to the substrates 120 and 30), thus changing the alignment of the liquid-crystal molecules within the liquid-crystal layer 40. This change causes unintended light transmission to possibly cause faulty display that is visually recognized as green unevenness.

In contrast, the liquid-crystal panel 10 according to this preferred embodiment is configured, as shown in FIG. 4, such that the isolated light-blocking film 52, which is a part of the light-blocking film 50 located in the non-display area NAA and is adjacent to where the silver paste 17 is disposed, is isolated from the main light-blocking film 51, which is the remaining part of the light-blocking film 50. The light-blocking film 50 in this preferred embodiment is disposed with a pattern in which an isolation band S without a light-blocking film is interposed between the main light-blocking film 51 and the isolated light-blocking film 52. That is, the light-blocking film 50 according to this preferred embodiment includes the main light-blocking film 51 and the light-blocking film 52 isolated from the main light-blocking film 51. The main light-blocking film 51 includes the whole inter-pixel light-blocking portion 51A, disposed in the display area AA, and a frame-shaped light-blocking portion 51B disposed in most of the non-display area NAA. The isolated light-blocking film 52 is composed of a frame-shaped light-blocking portion disposed in part of the non-display area NAA. The isolated light-blocking film 52, which is disposed in the non-display area NAA, does not cause faulty display, even when the silver paste 17 comes into contact with the isolated light-blocking film 52 at the right side edge 20A of the CF substrate 20, over which the silver paste 17 extends, and thus causes the potentials of the conductive film 60, ground 16, and other things to transmit to the isolated light-blocking film 52. In addition, the main light-blocking film 51 and the isolated light-blocking film 52, with the isolation band S1 interposed therebetween, are electrically isolated from each other. The display area AA is hence less likely to receive the potentials from the isolated light-blocking film 52. Such a configuration reduces an instance where the potentials of the conductive film 60 and ground 16 are transmit into the display area AA, thus generating an unintended electric field in the display area AA. An occurrence of faulty display is consequently prevented.

As shown in FIG. 3, the liquid-crystal panel 10 according to this preferred embodiment further includes the overcoat film 23 that integrally covers the entire surface of the light-blocking film including the main light-blocking film 51 and the isolated light-blocking film 52. That is, the overcoat film 23, disposed on the surface of the inter-pixel light-blocking portion 51A adjacent to the liquid-crystal layer 40 and thus serving as an insulating protective film, extends also to the non-display area NAA as it is, to be contiguous to the surfaces of the main light-blocking films 51 and isolated light-blocking film 52 adjacent to the liquid-crystal layer 40, thus serving as an insulating blockage film. The entire surface of the light-blocking film 50 along with the isolation band S1 is covered with the insulating overcoat film 23 in this way. This substantially regulates contact between the silver paste 17 and the main light-blocking film 51. As a result, an instance where the potentials of the conductive film 60 and ground 16 transmit into the display area AA can be prevented greatly with high reliability.

As described above, the liquid-crystal panel 10 (which is an example of a display panel) according to the first preferred embodiment includes the following: the CF substrate 20 (which is an example of a first substrate) and the array substrate 30 (which is an example of a second substrate) facing each other and the liquid-crystal layer 40 that is disposed between the CF substrate 20 and the array substrate 30, and is made of a liquid-crystal material (which is an example of an electro-optical substance). The liquid-crystal panel 10 is sectioned into a display area where an image is displayed, and a non-display area where an image is not displayed. The CF substrate 20 includes the light-blocking film 50 that is disposed in the display area AA and the non-display NAA, and is adjacent to the liquid-crystal layer 40. The light-blocking film 50 is conductive and impervious to light. The CF substrate 20 also includes the conductive film 60 that is remote from the liquid-crystal layer 40 and is conductive. The display panel 10 includes the ground 16 that is disposed outside the CF substrate 20 and is kept at a ground potential. The conductive film 60 and the ground 16 are connected together by the silver paste 17 (which is an example of a connector) that is conductive and extends over the right side edge 20A (which is an example of a side edge) of the CF substrate 20 disposed in the non-display area NAA. The light-blocking film 50 includes the main light-blocking film 51A including the inter-pixel light-blocking portion 51A (which is an example of an intra-display-area light-blocking portion) disposed in the display area AA. The light-blocking film 50 also includes the isolated light-blocking film 52 disposed in the non-display area NAA including a portion of the right side edge 20A adjacent to where the silver paste 17 is disposed. The isolated light-blocking film 52 is electrically isolated from the main light-blocking film 51A.

The aforementioned configuration enables the potentials of the conductive film 60 (which is used for shielding) and ground 16 to be less likely to transmit into the display area AA, using a simple configuration where the isolated light-blocking film 52 is isolated from the main light-blocking film 51. That is, since the isolated light-blocking film 52 near the silver paste 17 is disposed in the non-display area NAA and is insulated from the main light-blocking film 51 including the inter-pixel light-blocking portion 51A within the display area AA, the potentials of the conductive film 60 and ground 16 do not transmit into the display area AA even when the isolated light-blocking film 52 near the silver paste 17 comes into contact with the silver paste 17. Further, the isolated light-blocking film 52 is closer to the right side edge 20A than the main light-blocking film 51 including the inter-pixel light-blocking portion 51A is. This prevents the silver paste 17 from contact to the end surface of the main light-blocking film 51 and other things. As a result, such a simple configuration enables the potentials of the conductive film 60 (which is used for shielding) and ground 16 to be less likely to transmit into the display area AA, thereby preventing an occurrence of faulty display. Here is a comparison between the above configuration and a configuration of forming a cutout in an appropriate location of a light-blocking film and further forming a protrusion, to prevent contact between the light-blocking film and a connector. In the above configuration, part of the light-blocking film 50, conventionally provided integrally, is isolated. The above configuration is thus significantly simple and does not complicate the manufacturing process steps. In addition, the isolated light-blocking film 52 is placed also near the silver paste 17, thus reducing light leakage at this site.

The liquid-crystal panel 10 according to this preferred embodiment is configured such that the second substrate includes a pair of electrodes for applying an electric field to the electro-optical substance, and the ground. The liquid-crystal panel 10 having the above configuration includes a pair of substrates 33 and 35 that are disposed on the array substrate 30 and are used for applying an electric field to the electro-optical substance. The liquid-crystal panel 10 is configured such that the CF substrate 20 has no electrode. Hence, the liquid-crystal panel 10 easily exhibits charge-up. To address this problem, the CF substrate 20 is provided with the conductive film 60 for shielding. The present technique is useful particularly for such a transverse-field display panel. Moreover, the ground 16 can be composed of a conductive film composed of a predetermined pattern of laminated layers on the array substrate 30.

The liquid-crystal panel 10 according to this preferred embodiment includes the overcoat film 23 that is disposed on the CF substrate 20 to extend continuously from a surface of the isolated light-blocking film 52 adjacent to the liquid-crystal layer 40 to a surface of the main light-blocking film 51 adjacent to the liquid-crystal layer 40. The overcoat film 23 is insulating and serves as an insulating blockage film. In such a configuration, the isolated light-blocking film 52 and the overcoat film 23 make it difficult for the silver paste 17 to get close to the end of the main light-blocking film 51 adjacent to the right side edge. This effectively prevents contact between the main light-blocking film 51 and the silver paste 17. In an exemplary configuration where the aforementioned cutout and protrusion are used to prevent contact between the light-blocking film and the connector, the end of the light-blocking film is exposed at the back of the protrusion; in addition, depending on conditions for applying the connector and on other things, the connector can extend to the back of the protrusion to come into contact with the end of the light-blocking film. The above configuration in contrast can reduce the possibility of contact between the main light-blocking film 51 and the silver paste 17 greatly. It is noted that in the above configuration, part of the overcoat film 23 may be interposed between the main light-blocking film 51 and the isolated light-blocking film 52.

The liquid-crystal panel 10 according to this preferred embodiment is configured such that the CF substrate 20 includes the overcoat film 23 disposed on a surface of the inter-pixel light-blocking portion 51A adjacent to the liquid-crystal layer 40. The overcoat film 23 is insulating and serves as an insulating protective film. The overcoat film 23 is a single-piece film in which a portion serving as an insulating protective film in the display area AA, and a portion serving as an insulating blockage film in the non-display area NAA are contiguous. In other words, the insulating overcoat film 23 is flatly disposed on the CF substrate 20, above the light-blocking film 50 (i.e., closer to the liquid-crystal layer 40 than the light-blocking film 50) so as to cover the entire surface of the CF substrate 20. In such a configuration, a surface that extends from the isolated light-blocking film 52 to the inter-pixel light-blocking portion 51A of the main light-blocking film 51 and is adjacent to the liquid-crystal layer 40 is continuously covered with the overcoat film 23, which serves as an insulating blockage film and an insulating protective film. This regulates contact between the main light-blocking film 51 and the silver paste 17 with higher reliability. Such an overcoat film 23 that integrally includes an insulating blockage film and an insulating protective film can be formed by, for instance, forming the light-blocking film 50 with a predetermined pattern including the main light-blocking film 51 and isolated light-blocking film 52 onto one of the surfaces of the CF substrate 20, followed by forming the insulating overcoat film 23 to cover all the films. Since it is common to cover, with the overcoat film 23, the surface of the light-blocking film 50 adjacent to the liquid-crystal layer 40, the above configuration is achieved without additional process steps and other things, by only changing the pattern when the light-blocking film is formed in a conventional process step for manufacturing a CF substrate.

The liquid-crystal panel 10 according to this preferred embodiment is configured such that the silver paste 17 is a conductive paste. The present technique is particularly useful in connecting together the conductive film 60 and the ground 16 by the use of a conducive paste with which accurate adjustment of a placement range is difficult.

The liquid-crystal display 1 according to this preferred embodiment includes the foregoing liquid-crystal panel 10. Such a configuration reduces unintended electric fields in the display area AA, thereby preventing faulty display in the liquid-crystal display 1.

### Second Preferred Embodiment

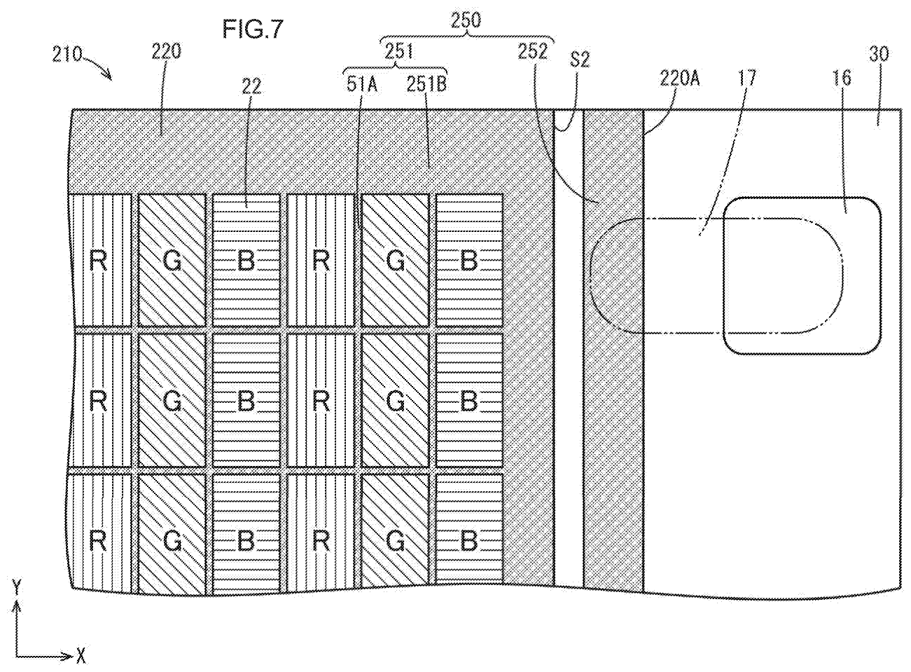

A second preferred embodiment will be described with reference to FIG. 7. This preferred embodiment describes a liquid-crystal panel 210 that includes an isolated light-blocking film 252. The isolated light-blocking film 252 is provided in a manner different from that in the isolated light-blocking film 52 of the liquid-crystal panel 10 according to the first preferred embodiment. Like components between the first and second preferred embodiments will be denoted by the same signs and will not be elaborated upon. It is noted that a third preferred embodiment will be addressed similarly.

In this preferred embodiment, the isolated light-blocking film 252, included in a light-blocking film 250 on a CF substrate 220, extends along the entire length of a right side edge 220A of the CF substrate 220, as shown in FIG. 7. That is, an isolation band S2 extends in substantial parallel to the right side edge 220A. The isolation band S2 isolates the isolated light-blocking film 252 from a main light-blocking film 251 including the inter-pixel light-blocking portion 51 and a frame-shaped light-blocking portion 251B.

As described above, the liquid-crystal panel 210 according to this preferred embodiment is configured such that the isolated light-blocking film 252 is disposed on the CF substrate 220 to extend along the entire length of the right side edge 220A. Such a configuration can further reduce the possibility that an unintended potential transmits into the display area AA. For instance, there is a case where, at the time of applying a paste substance, which is herein the silver paste 17, the paste substance scatters at any location at the right side edge 220A of the CF substrate 220 to adhere to the conductive film 60 and the light-blocking film 250. Even in this case, the potentials of the conductive film 60 and other things are less likely to transmit into the display area AA via the scattered paste substance.

### Third Preferred Embodiment

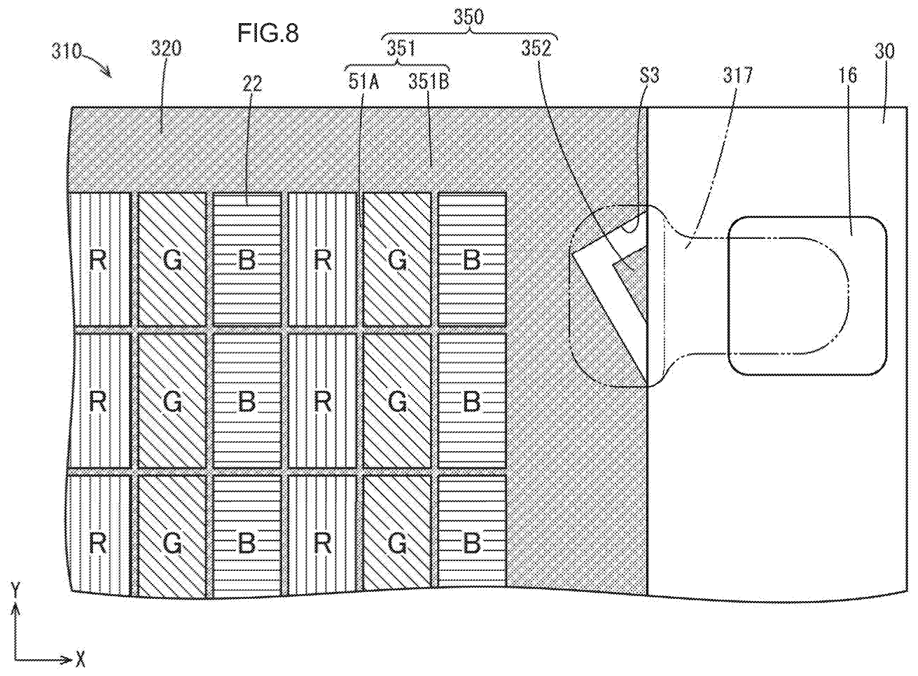

A third preferred embodiment will be described with reference to FIG. 8. This preferred embodiment describes a liquid-crystal panel 310 that includes a silver paste 317. The silver paste 317 is disposed in a manner different from that in the silver paste 17 of the liquid-crystal panel 10 according to the first preferred embodiment.

In this preferred embodiment, FIG. 8 shows a relatively small, isolated light-blocking film 352 that is included in a light-blocking film 350 disposed on a CF substrate 320. When the liquid-crystal panel 310 is viewed from its front surface, the silver paste 317 covers an isolation band S3 that isolates the isolated light-blocking film 352 from a main light-blocking film 351 including the inter-pixel light-blocking portion 51A and a frame-shaped light-blocking portion 351B. Accordingly, the silver paste 317, impervious to light, electrically connects together the ground 16 on the array substrate 30 and the conductive film 60 while covering the isolation band S3, having no light-blocking film, from the transparent substrate 21 and the front surface of the transparent conductive film 60.

As described above, the liquid-crystal panel 310 according to this preferred embodiment is configured such that the silver paste 317, used as a connector, is impervious to light, and covers the isolation band S3 (i.e., an area between the isolated light-blocking film 352 and the main light-blocking film 351) in plan view. The isolated light-blocking film 352 in this preferred embodiment is electrically isolated from the main light-blocking film 351. For this reason, providing the isolation band S3 that has no lightproof substance, between the light-blocking films 351 and 352 can cause light leakage from the isolation band S3. In the above configuration, the silver paste 317, impervious to light, covers the isolation band S3 from the front surface, thereby preventing light leakage from the isolation band S3.

### Other Preferred Embodiments

The present technique disclosed in the Specification is not limited to the foregoing preferred embodiments described above using the drawings. Preferred embodiments described below for instance are also included in the technical scope of the technique.

(1) In the first or second preferred embodiment, the silver paste 17 may be applied to cover the isolation band S1 or S2.

(2) The foregoing preferred embodiments have described, by way of example only, a configuration where the conductive film and the ground are connected together at one location. For instance, multiple grounds may be provided, and the conductive film and the grounds may be connected together at multiple locations by a connector. In this case, multiple connectors may be provided to extend over different side edges of a CF substrate for instance.

(3) The foregoing preferred embodiments have described, by way of example only, an instance where the ground is disposed on the second substrate. For instance, a display panel and a casing for an illumination device installed in the display panel may be made of conductive metal or other materials, and part of the metal may be connected to a conductive film on the first substrate as a ground.

(4) The foregoing preferred embodiments have described, by way of example only, a configuration where the insulating overcoat film is flatly disposed on the entire surface of the CF substrate. An insulating blockage film that blocks the space between an isolated light-blocking film and a main light-blocking film to regulate entrance of the connector may be isolated from an insulating protective film that protects the surface of an intra-display-area light-blocking portion. At least the perimeter of the main light-blocking film is preferably covered with an insulating film.

(5) The foregoing preferred embodiments have described, by way of example only, an instance where a silver paste is used as the connector. The present technique is applicable to a configuration where not only a paste made of a conductive material other than silver, but also conductive tape is used. The connector is preferably impervious to light when used as a light-blocking member that regulates light leakage.

(6) The foregoing preferred embodiments have described a display panel that operates in FFS mode. The present technique is effectively applicable to a display panel in other transverse-field modes, such as an IPS mode, and to other types of display panel. Other than a transverse-field display panel, the present technique is also applicable to a display panel having two substrates, one of which is provided with a conductive film and a light-blocking film, and the other of which is provided with a ground. This display panel is configured such that the ground and the conductive film are electrically connected together by a conductive connector.

(7) Although the foregoing preferred embodiments have described, by way of example only, a rectangular display panel that has the rectangular display area AA, the display panel may have any shape. The present technique is also applicable to a display panel having any shape in plan view, including a circle, an ellipse, and an indefinite shape, and is applicable to a display panel that is bent or curved three-dimensionally.

(8) The display panel may or may not be provided with an illumination device. The foregoing preferred embodiments each have described, by way of example only, an instance where the present technique is applied to a liquid-crystal panel made of a liquid-crystal material, which is an electro-optical substance. The present technique is also applicable to other kinds of display panel, including an organic EL panel, a plasma display panel (PDP), an electrophoretic-display (EPD) panel, and a micro-electro-mechanical-systems (MEMS) display panel.

What is claimed is:

1. A display panel comprising:
first and second substrates facing each other; and
an electro-optical substance disposed between the first and second substrates,
the display panel being sectioned into a display area where an image is displayed, and a non-display area where an image is not displayed,
the first substrate comprising
a light-blocking film that is disposed in the display area and the non-display, and is adjacent to the electro-optical substance, the light-blocking film being conductive and impervious to light, and
a conductive film that is remote from the electro-optical substance, the conductive film being conductive,
the display panel comprising a ground disposed outside the first substrate, the ground being kept at a ground potential,
the conductive film and the ground being connected together by a connector that is conductive and extends over a side edge of the first substrate located in the non-display area,
the light-blocking film comprising
a main light-blocking film including an intra-display-area light-blocking portion disposed in the display area, and
an isolated light-blocking film disposed in the non-display area including a portion of the side edge adjacent to where the connector is disposed, the isolated light-blocking film being electrically isolated from the main light-blocking film.

2. The display panel according to claim 1, wherein
the second substrate comprises
a pair of electrodes for applying an electric field to the electro-optical substance, and
the ground.

3. The display panel according to claim 1, wherein the first substrate comprises an insulating blockage film that is insulating, the insulating blockage film extending continuously from a surface of the isolated light-blocking film adjacent to the electro-optical substance to a surface of the main light-blocking film adjacent to the electro-optical substance.

4. The display panel according to claim 3, wherein the first substrate comprises an insulating protective film that is insulating, the insulating protective film being disposed on a surface of the intra-display-area light-blocking portion adjacent to the electro-optical substance, and
the insulating blockage film is contiguous to the insulating protective film.

5. The display panel according to claim 1, wherein the isolated light-blocking film extends along an entire length of the side edge of the first substrate.

6. The display panel according to claim 1, wherein the connector is impervious to light, and covers an area located between the isolated light-blocking film and the main light-blocking film in a plan view.

7. The display panel according to claim 1, wherein the connector comprises a conductive paste.

8. A display device comprising the display panel according to any one of claim 1.
